(19) United States
(12) Patent Application Publication
(10) Pub. No.: US 2010/0145571 A1
(43) Pub. Date: Jun. 10, 2010

(54) IN-VEHICLE TERMINAL FOR DIAGNOSING VEHICLE USING OBD CONNECTOR

(75) Inventors: Keekoo KWON, Daegu (KR); Jaeyoung KIM, Daegu (KR); Eunryung LEE, Daegu (KR); Joonhak BANG, Daegu (KR); Sungho AHN, Daegu (KR); Jonguk KIM, Daegu (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/632,329

(22) Filed: Dec. 7, 2009

(30) Foreign Application Priority Data
Dec. 8, 2008 (KR) 10-2008-0124223

(51) Int. Cl. G06F 7/00

(52) U.S. Cl. 701/33

(57) ABSTRACT

Provided is an in-vehicle terminal including: a GPS receiving unit that receives GPS signals; a communication interface unit that is connected to the vehicle diagnosis connector and receives auto diagnosis information from the vehicle diagnosis connector, and communicates with an electronic control unit in the vehicle through the vehicle diagnosis connector; a control unit that receives and processes the auto diagnosis information and the GPS signal, and calculates traveling information, information about driving conditions, information about parts conditions, and information about replacement of consumables, in order to allow a driver to diagnose condition of the vehicle; and an interactive unit that displays the traveling information, information about driving conditions, information about parts conditions, and information about replacement of consumables for a driver.

### RELATED APPLICATIONS

The present application claims priority to Korean Patent Application Serial Number 10-2008-0124223, filed on Dec. 8, 2008, the entirety of which is hereby incorporated by reference.

### BACKGROUND OF THE INVENTION

1. Field of the Invention

The present invention relates to an in-vehicle terminal for diagnosing a vehicle using an OBD connector. In detail, the present invention relates to an in-vehicle terminal for diagnosing a vehicle using an OBD connector equipped in the vehicle.

2. Description of the Related Art

‘OBD’ is the simpler form for ‘On Board Diagnosis’ and an OBD connector that is an auto diagnosing connector for vehicles is provided on a dashboard of all vehicles that are released at present (see FIG. 1). The range of auto diagnosis for vehicles has increased with the development of technology, such that more inclusive OBD laws have been enacted under the leadership of CARE (California Air Resource Board). Accordingly, an OBD-II has been developed, in which a lot of vehicle auto diagnosis functions have been added for new systems. For example, catalyst converter diagnosis, accidental fire diagnosis, canister purge diagnosis, secondary air system diagnosis, etc. have been supplemented. Further, the communication methods are being standardized by each of the vehicle manufactures.

Therefore, it has been possible to perform vehicle auto diagnosis by a vehicle diagnosis connector (e.g. OBD-II connector) provided in vehicles. However, since vehicle diagnosis devices are generally provided in auto repair shops, drivers have to visit an auto repair shop and check a malfunction in a vehicle after connecting a vehicle diagnosis device to a vehicle diagnosis connector, when a malfunction is suspected in parts of the vehicle or wanting to check malfunction of the vehicle. In this case, there is a problem in that the driver has to visit an auto repair shop in person.

Due to the problem, some vehicle diagnosis systems including a blackbox system for a vehicle are on the market around the world. However, most of these systems are systems that collect information of vehicle conditions, transmit the information to a specific remote server using a wire/wireless network for analysis, and then supply the information to a driver.

Further, systems that are connected to a vehicle diagnosis connector and directly provide various information of vehicle conditions to drivers have been on the market, but have a problem in that they have to be provided with a specific hardware device to connect the vehicle diagnosis connector of a vehicle with a navigation terminal.

### SUMMARY OF THE INVENTION

The present invention addresses the problem described above and it is an object of the present invention to allow a driver to drive safely and economically by receiving and processing various auto diagnosis information, which is transmitted through a communication interface unit connected to a vehicle diagnosis connector (OBD-II connector) equipped in a vehicle, using an in-vehicle terminal including a navigation system, and providing the driver with traveling information, information about driving conditions, information about parts conditions, and information about replacement of consumables.

An in-vehicle terminal of the present invention is an in-vehicle terminal connected to a vehicle diagnosis connector mounted in the vehicle to diagnose a vehicle, which includes: a GPS receiving unit that receives GPS signals; a communication interface unit that is connected to the vehicle diagnosis connector and receives auto diagnosis information from the vehicle diagnosis connector, and communicates with an electronic control unit in the vehicle through the vehicle diagnosis connector; a control unit that receives and processes the auto diagnosis information and the GPS signal, and calculates and outputs traveling information, information about driving conditions, information about parts conditions, and information about replacement of consumables, by a stored program, in order to allow a driver to diagnose conditions of the vehicle; and an interactive unit that displays the traveling information, information about driving conditions, information about parts conditions, and information about replacement of consumables for a driver.

In particular, the communication interface unit obeys the OBD-II connector standard (SAE J-1962) and supports one or more protocols in ISO, KWP, PWM, CAN, and VWP communication protocols.

Further, the communication interface unit receives auto diagnosis information from the vehicle diagnosis connector, by using one or more wireless communication methods of Bluetooth, IrDA, and ZigBee.

Further, the in-vehicle terminal further includes a power supply unit that converts power from a battery of the vehicle which is supplied from a connecting terminal of the vehicle diagnosis connector into supply power of the in-vehicle terminal and supplies the power to the in-vehicle terminal.

Further, the driving information includes information on one or more of present velocity, average fuel consumption rate, possible traveling distance, average fuel efficiency, instantaneous fuel efficiency, and average RPM.

Further, the information about traveling conditions is information that shows whether the driving condition of the vehicle corresponds to low-velocity driving, over-velocity driving, or economical driving.

Further, the in-vehicle terminal further includes a storage unit that stores map data of the national map, path guide data involved in the map data, and a path guide control program, in which the control unit controls execution of a user interface for path search and path setting, creates a path guide object on the map that guides path for a destination selected by a driver, using the stored map data and the path guide control program.

Further, the storage unit divides the national map by grids of predetermined meshes and stores the map data for each grid, and stores index information given with an index for each of the grids.

According to the present invention, it is possible to achieve the following effects.

Since it is not necessary to provide a specific hardware device for connecting an in-vehicle terminal having a vehicle diagnosis connector and a display means to perform vehicle diagnosis as in the related art, it is possible to prevent the inside of a vehicle from complicated and allow a driver to drive in a pleasant environment.

Further, by continuously providing a driver with traveling information, information about driving conditions, information about parts conditions, and information about replacement of consumables, the driver can drive safely and economically. In detail, it is possible to check and fix a vehicle in advance before it breaks, and achieve safe driving and reduction of cost by replacing the consumables and parts of the vehicle at the appropriate time. Further, it is possible to save the fuel by correcting the driving habit.

### BRIEF DESCRIPTION OF THE DRAWING

FIG. 1 is a view showing an OBD-II connector, which is a vehicle diagnosis connector, equipped in a vehicle;

FIG. 2 is a diagram schematically illustrating an in-vehicle terminal for diagnosing a vehicle using an OBD connector;

FIG. 3 is a diagram illustrating in detail the in-vehicle terminal for diagnosing a vehicle using an OBD connector; and

FIG. 4 is a diagram illustrating an example of a user interface provided by the in-vehicle terminal of the present invention.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

Hereinafter, preferred embodiments of the present invention will be described in detail with reference to the accompanying drawings.

FIG. 2 is a diagram schematically illustrating an in-vehicle terminal for diagnosing a vehicle using an OBD connector.

An in-vehicle terminal that can diagnose a vehicle is connected to a vehicle diagnosis connector 1 through a communication interface unit and receives auto diagnosis information transmitted through the vehicle diagnosis connector 1. Further, the in-vehicle terminal 100 (a vehicle terminal) receives auto diagnosis information of a vehicle from the vehicle diagnosis connector 1, processes the information, and then provides a driver with traveling information, information about driving conditions, information about parts conditions, and information about replacement of consumables, etc. Therefore, the driver can drive safely and economically. The vehicle diagnosis connector 1 may be an OBD-II connector herein.

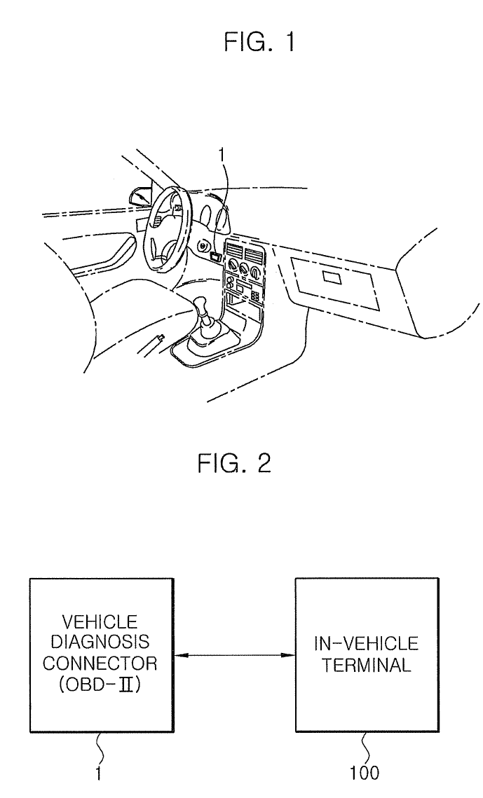

As shown in FIG. 1, all the vehicles that are launched at present are provided with a vehicle diagnosis connector on the dashboard of the vehicles. Accordingly, vehicles using a communication protocol under the OBD laws can perform auto diagnosis for the vehicles, using the in-vehicle terminal according to the present invention.

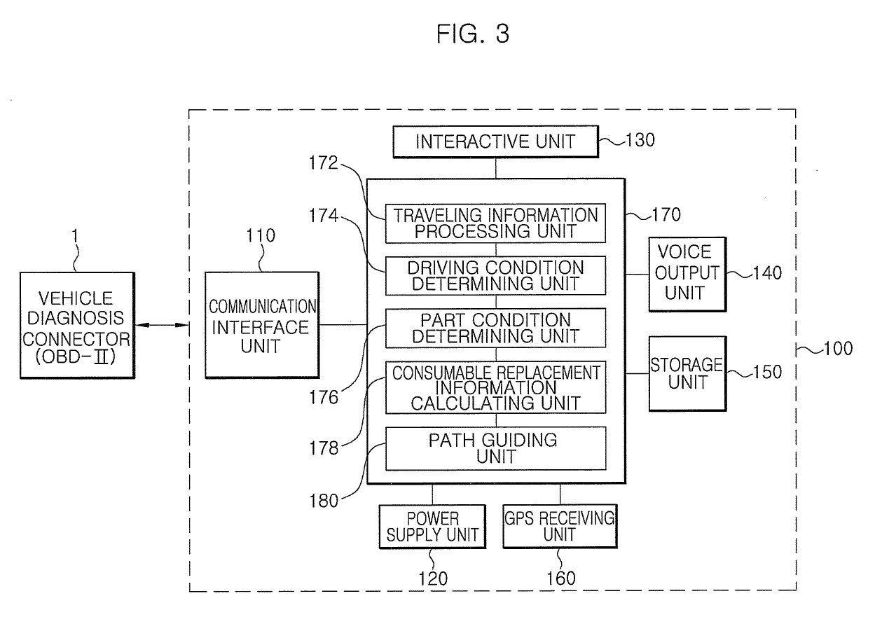

FIG. 3 is a diagram illustrating in detail the in-vehicle terminal for diagnosing a vehicle using an OBD connector.

The in-vehicle terminal 100 according to the present invention includes a communication interface unit 110 that is connected to the vehicle diagnosis connector 1 for communication, a power supply unit 120 that supplies power that the in-vehicle terminal 100 can use, an interactive unit 130 for a user interface, a voice output unit 140, a storage unit 150 that stores programs and data needed for implementing the present invention, a GPS receiving unit 160 that receives GPS signals from a satellite, and a control unit 170 that extracts and calculates traveling information, information about driving conditions, information about parts conditions, and information about replacement of consumables, etc. such that a driver can diagnose the vehicle by himself/herself, by processing the auto diagnosis information transmitted from the vehicle diagnosis connector 1.

An in-vehicle terminal that can diagnose a vehicle having the above configuration according to the present invention is described in detail with reference to FIG. 3.

The communication interface unit 110 is connected to the vehicle diagnosis connected 1 in a vehicle by wire/wireless and performs auto diagnosis communication with an electronic control unit (not shown) in the vehicle through the vehicle diagnosis connector 1, and receives auto diagnosis information from the electronic control unit through the communication. When the vehicle diagnosis connector 1 is an OBD-II connector, the OBD-II connector supports ISO, KWP, PWM, CAN, and VWP communication protocols, the communication interface unit 110 connected to the vehicle diagnosis connector 1 should observe an OBD-II connector standard (SAE J-1962) and supports one or more of the ISO, KWP, PWM, CAN, and VWP communication protocols. The electronic control unit in a vehicle implies all the electronic control units (ECU) in the vehicle, such as the transmission control unit (TCU), suspension control unit, and brake control unit. In addition to a vehicle control function, the electronic control unit stores or outputs the condition of the vehicle detected in traveling as a portion of auto diagnosis information or traveling information of the vehicle. The communication protocol according to the OBD standard can be changed in accordance with the international regulations and the aspect of the present invention is not limited thereto. That is, it should be construed that a configuration of a communication interface unit corresponding to the international regulations is included in the aspect of the present invention.

When the communication interface unit 110 is implemented by wire, the communication interface unit 110 can provide interfaces, such as USB and RS-232, such that the auto diagnosis information received through the vehicle diagnosis connector 1 can be transmitted to the control unit 170.

On the other hand, when the communication interface unit 110 is implemented by wireless, the communication interface unit 110 can be composed of a first communication module 1 that is attached to the vehicle diagnosis connector 1 and performs communication by using a wireless communication, such as Bluetooth, IrDA, and ZigBee, and a second communication module that is disposed in the in-vehicle terminal 100 and communicates with the first communication module attached to the vehicle diagnosis connector 1, using wireless communication, such as Bluetooth, IrDA, and ZigBee. When the communication interface unit 11 is implemented by wireless, a specific cable is not needed, such that it is not necessary to consider a wire design around the driver's seat.

Meanwhile, setting connection to allow for communication using the above communication method is a technology known in the art and detailed description is not provided.

The power supply unit 120 supplies power that the in-vehicle terminal according to the present invention can use. The power supply unit 120 converts the power supplied through the connection terminal of the vehicle diagnosis connector 1 into power that the in-vehicle terminal can use, and then supplies the power, when the communication interface unit 10 is implemented by wire. That is, the power supply unit 120 adjusts the power (e.g., 12V or 14V) supplied from the vehicle diagnosis connector 1 into an operation voltage (3V or 3.3V) of the in-vehicle terminal of the present invention, and then provides the power.

According to this configuration, the in-vehicle terminal according to the present invention does not need a specific battery and it is possible to reduce the volume and the cost while easily mounting the in-vehicle terminal in a vehicle.

However, when the communication interface unit 10 is implemented by wireless, it is required to receive power from a specific power source outside and convert the power into a power that can be used by the in-vehicle terminal according to the present invention and then supply the power, or it is required to receive power from a built-in battery and converts the power into power that can be used by the in-vehicle terminal according to the present invention and then supply the power.

The voice output unit 140 is a mechanical or an electronic voice generator that receives traveling information, information about driving conditions, information about parts conditions, and information about replacement of consumables, etc. from the control unit 170 and creates a voice, such as an alarm, on the basis of the information.

The storage unit 150 stores programs and data needed for implementing the present invention. It is preferable that the storage unit 150 stores in real time auto diagnosis information inputted through the vehicle diagnosis connector 1 and it is preferable that the storage unit 150 is a flash memory or RAM to provide the control unit 170 with the auto diagnosis information.

Further, the storage unit 150 applied to the present invention stores 2D- or 3D-map data such that the in-vehicle terminal 100 can provide the function of a navigator. The storage unit 150 stores map data for the whole country and data provided with path guide data involved in the map data. Further, the storage unit 150 stores a path guide control program for controlling the overall operation of a navigation system including the path guide function, a GUI (Graphic user interface) control program that controls execution of the user interface for path search and path setting, and a search control program that controls search of facilities for at least one item around the search path. The storage unit 150 divides the national map by grids of predetermined meshes and stores data for each grid. Further, an index is given to each grid and index information is stored, such that it is possible to manage and access the map data for each grid, using the index information. In particular, it is preferable to store facility information classified by various facilities on the map, such as a hospital, pharmacy, gas station, parking lot, bank, accommodation, restaurant, convenience store, and subway, as bit-information in the index information of the storage unit 150. Further, a variety of programs can be stored. For example, programs allowing for the functions of car keeping book, game, movie player, and MP3 player can be stored.

The GPS receiving unit 160 receives GPS signals from a satellite.

When an auto diagnosis order is inputted through the interactive unit 130 by a driver, the control unit 170 receives and processes auto diagnosis information and a GPS signal transmitted from the vehicle diagnosis connector 1 and the GPS receiving unit 160, respectively, and then extracts and calculates the traveling information, information about driving conditions, information about parts conditions, and information about replacement of consumables, etc. such that the driver can diagnose the vehicle by himself/herself.

In detail, when receiving an auto diagnosis order from a driver, the control unit 170 creates a message including the auto diagnosis order and transmits the message to the electronic control unit in the vehicle through the vehicle diagnosis connector 1. Accordingly, the electronic control unit in the vehicle receives the message including the auto diagnosis order from the in-vehicle terminal 100 according to the present invention. As the auto diagnosis request is transmitted from the in-vehicle terminal 100, the electronic control unit in the vehicle extracts auto diagnosis information for each part of the vehicle stored in the memory means and transmits it to the vehicle diagnosis connector 1, using a K-line or a CAN communication and the auto diagnosis information is transmitted to the in-vehicle terminal 100 by wire or wireless from the vehicle diagnosis connector 1. Although the electronic control unit extracts the auto diagnosis information stored in the memory in response to the auto diagnosis request in this embodiment of the present invention, the electronic control unit may perform auto diagnosis for each part of the vehicle and transmit the present auto diagnosis information in real time, when the auto diagnosis is requested. Meanwhile, the ‘process’ in the control unit 170 inclusively implies information analysis, execution of comparing calculation, auto diagnosis communication for acquiring auto diagnosis information (internal information of the vehicle), and operation of outputting the auto diagnosis information to outside devices, in which the outside device includes an information processing terminal, such as a CDMA terminal, a smart phone, a PDA, a computer, a notebook, and a terminal at an auto repair shop.

In order to achieve the above, the control unit 170 applied to the present invention includes a traveling information processing unit 172, a driving condition determining unit 174, a part conditions determining unit 176, a consumable replacement information calculating unit 178, and a path guiding unit 180.

The traveling information processing unit 172 extracts traveling information for safe driving or calculates it after comparing calculation, using the auto diagnosis information received from the communication interface unit 110. In detail, the traveling information processing unit 172 extracts and calculates the present traveling velocity, average fuel consumption rate, possible traveling distance, average fuel efficiency, instantaneous fuel efficiency, and average RPM etc., and provides them for the driver (user) through the GUI of the interactive unit 130 and the voice output unit 140.

The driving condition determining unit 174 checks the driving condition of the driver behind the wheel and then informs the driver of the present driving condition through the GUI of the interactive unit 130 and the voice output unit 140. In detail, the driving condition determining unit 174 checks whether the present driving condition is low-velocity driving, over-velocity driving, or economical driving, and inform the driver of the result.

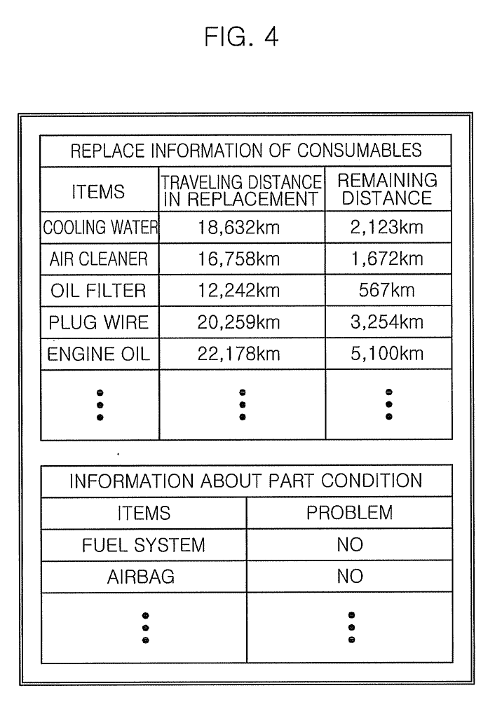

The part conditions determining unit 176 receives signals about a problem of the parts mounted or installed in the vehicle which is transmitted through the vehicle diagnosis connector 1, checks and processes condition information of corresponding parts (i.e., information about a problem of the parts), and provides the driver with the result through the GUI of the interactive unit 130 and the voice output unit 140. For example, as shown in FIG. 4, it provides the driver with information about a problem installed in the parts, such as a fuel system and an airbag.

The consumable replacement information calculating unit 178 receives the auto diagnosis information transmitted from the vehicle diagnosis connector 1, processes it, and then provides the driver with replacement information of the consumables mounted or installed in the vehicle, through the GUI of the interactive unit 130 and the voice output unit 140. For example, as shown in FIG. 4, it provides the driver with replacement information (e.g., replacement period) of the consumables in the vehicle, such as the cooling water, air cleaner, oil filter, plug wire, and engine oil. The traveling distance that is inputted in replacing is the traveling distance when the drive replaces the consumables.

According to the configuration described above, the auto diagnosis information outputted through the vehicle diagnosis connector 1 is acquired in the control unit 170 by communication with the electronic control unit in the vehicle, and the control unit 170 manages the vehicle information, vehicle auto diagnosis information, and vehicle traveling information. Further, the control unit 170 can provide various services, such as warning the driver or a third person through the interactive unit 130 and the voice output unit 140, by performing comparing calculation by the program stored in the storage unit 150. Furthermore, it can transmit the acquired information and processed information to outside information output devices.

Further, the in-vehicle terminal 100 according to the present invention can analyze the driving propensity of the driver by analyzing malfunction of the vehicle and driving condition, and check rapid acceleration, rapid braking, overspeed, and overheat of the engine, and inform the driver of them through the interactive unit 130 and the voice output unit 140.

The path guiding unit 180 controls the overall operation of the navigation system, including the path guide function, by using the path guide control program and map data stored in the storage unit 150. Further, the path guiding unit 182 allows for creating a path guide object on the map for the destination selected by the driver and displaying it by the interactive unit 130, using the GUI (Graphic user interface) control program that controls execution of the user interface for path search and path setting.

On the other hand, though not shown, the in-vehicle terminal according to the present invention may further include an outside communication interface unit (not shown) that can communicate with an outside terminal. The RS-232 or USB method can be used as the wire communication, and the Bluetooth, IrDA, and ZigBee can be used for wireless communication such that the RF communication is possible. A method of setting connection allowing for the communication is well known to those skilled in the art and detailed description is not provided.

Some steps of the present invention can be achieved as codes, which can be read by a computer, in a recording medium that the computer can read. The recording medium that the computer can read includes all types of recording devices storing data that can be read by a computer system. The recording medium that can be read by a computer may be ROM, RAM, CD-ROM, CD-RW, magnetic tape, floppy disk, HDD, optical disc, magneto-optic disc etc, and also includes a medium that is implemented in a carrier wave form (transmission by the internet). Further, the medium that can be read by a computer is distributed in computer systems connected by a network, and can be stored and executed as a code that the computer can read in a distribution method.

As described above, the preferred embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. An in-vehicle terminal for diagnosing a vehicle, which is connected to a vehicle diagnosis connector mounted in the vehicle, the in-vehicle terminal comprising:
a GPS receiving unit that receives GPS signals;
a communication interface unit that is connected to the vehicle diagnosis connector and receives auto diagnosis information from the vehicle diagnosis connector, and communicates with an electronic control unit in the vehicle through the vehicle diagnosis connector;
a control unit that receives and processes the auto diagnosis information and the GPS signal, and calculates and outputs traveling information, information about driving conditions, information about parts conditions, and information about replacement of consumables, by a stored program, in order to allow a driver to diagnose condition of the vehicle; and
an interactive unit that displays the traveling information, information about driving conditions, information about parts conditions, and information about replacement of consumables for a driver.

2. The in-vehicle terminal according to claim 1, wherein the communication interface unit obeys the OBD-II connector standard (SAE J-1962) and supports one or more protocols in ISO, KWP, PWM, CAN, and VWP communication protocols.

3. The in-vehicle terminal according to claim 1, wherein the communication interface unit receives auto diagnosis information from the vehicle diagnosis connector, by using one or more wireless communication methods of Bluetooth, IrDA, and ZigBee.

4. The in-vehicle terminal according to claim 1, further comprising a power supply unit that converts power from a battery of the vehicle which is supplied from a connecting terminal of the vehicle diagnosis connector into supply power of the in-vehicle terminal and supplies the power to the in-vehicle terminal.

5. The in-vehicle terminal according to claim 1, wherein the driving information includes information on one or more of present traveling velocity, average fuel consumption rate, possible traveling distance, average fuel efficiency, instantaneous fuel efficiency, and average RPM of the vehicle.

6. The in-vehicle terminal according to claim 1, wherein the information about traveling conditions is information that shows whether the driving condition of the vehicle corresponds to any one of low-velocity driving, over-velocity driving, or economical driving.

7. The in-vehicle terminal according to claim 1, further comprising:
a storage unit that stores map data of the national map, path guide data involved in the map data, and a path guide control program,
wherein the control unit controls execution of a user interface for path search and path setting and creates a path guide object on the map that guides path for a destination selected by a driver, using the stored map data and the path guide control program.

8. The in-vehicle terminal according to claim 7, wherein the storage unit divides the national map by grids of predetermined meshes and stores the map data for each grid, and stores index information given with a index for each of the grids.
